(19) United States
(12) Patent Application Publication
(10) Pub. No.: US 2014/0280656 A1
(43) Pub. Date: Sep. 18, 2014

(54) METHOD EMPLOYING AT LEAST ONE CENTRAL PROCESSING UNIT (CPU)

(71) Applicant: Alexandra Winkler-Teufel, Balgheim (DE)

(72) Inventor: Alexandra Winkler-Teufel, Balgheim (DE)

(73) Assignee: APPBYYOU GMBH, Balgheim (DE)

(21) Appl. No.: 14/351,644

(22) PCT Filed: Oct. 14, 2011
(86) PCT No.: PCT/EP2011/005153

§ 371 Date: Jun. 3, 2014

(51) Int. Cl. H04L 12/58

(52) U.S. Cl. CPC H04L 51/08
USPC 709/206

(57) ABSTRACT

The invention relates to a method which employs at least one CPU (10, 12, 14, 16) that has at least one network interface (18, 20, 22, 24) and one messaging program (26, 28, 30, 32), which receives a message (34) with a message text (36) and a file attachment (38) via the network interface (18, 20, 22, 24) in at least one operating condition. According to the invention, the messaging program (26, 28, 30, 32) automatically saves the file attachment (38), separately from the message text (36) of the message (34), at a memory location that is based upon the path information (40) of the message (34).

### STATE OF THE ART

The invention relates to methods involving at least one processing unit, in accordance with the preamble of claim 1.

A method involving at least one processing unit has already been proposed, which method has at least one network interface and one messaging program, which, in at least one operating state, receives a message containing a message text and a data attachment by way of the network interface.

### ADVANTAGES OF THE INVENTION

The invention proceeds from a method involving at least one processing unit, which method has at least one network interface and one messaging program, which, in at least one operating state, receives a message containing a message text and a data attachment by way of the network interface.

It is proposed that the messaging program automatically saves the data attachment separately from the message text of the message, at a memory location that is dependent on the path information of the message. A “processing unit” should particularly be understood to be a unit having data input, data processing, and data output. It is advantageous if the processing unit has at least a processor, a memory, input and output means and/or an operating program. Preferably, the components of the processing unit are disposed in a common housing. It is particularly advantageous if the processing unit is configured as a work station, as a mobile telephone, as a smartphone, as a notebook, as a tablet computer, as a server and/or as another computer that appears practical to a person skilled in the art. In particular, a “network interface” should be understood to be an interface that sends data by way of a network in at least one operating state. Preferably, the network interface sends data by way of a wired network and/or a wireless network, for example by way of the Internet and/or by way of a cellular network. Furthermore, a “messaging program” should particularly be understood to be a computer program that interprets the message and/or particularly displays it in one operating mode. In one embodiment, the messaging program is intended to display the message text to an operator, particularly separate from transmission and/or protocol data, by way of a display unit. Thus, in this embodiment, the messaging program is intended as an email program for an end user, for example. In another embodiment, the messaging program is intended to receive and automatically process the message. Thus, in this further embodiment, the messaging program is configured as an email server, for example, which advantageously files a data attachment in a network memory, in particular, in one operating mode. Preferably, the messaging program is configured as a messaging program for a type of message that appears practical to a person skilled in the art, but preferably for sending and/or receiving chat messages, of mobile phone messages such as MMS or push messages and/or, particularly preferably, for sending and/or receiving emails. In particular, a “message” should be understood to be electronically transmitted data, which are displayed to an operator, at least in part. Furthermore, a “message text” should be understood to be a part of the message that is advantageously displayed to the operator by the messaging program, particularly in the form of a text, in at least one operating state. In particular, a “data attachment” should be understood to be a part of the message that is intended to be carried out and/or opened by a program different from the messaging program. Preferably, the messaging program is intended to receive and save a data attachment configured as a file. For example, the data attachment could be configured as a media file, as a text document, as a file that can be executed by an operating program and/or as another file that appears practical to a person skilled in the art. The term “receive” should particularly be understood to mean that the messaging program accepts the data by way of the network interface, in accordance with a protocol that appears practical to a person skilled in the art. In particular, “path information” should be understood to be information that describes a memory type in a directory structure on an electronic data memory. Preferably, the path information is intended to allow an operator to find the data attachment by following a branch of the directory structure. The term “memory location” should particularly be understood to mean a location in the directory structure of the electronic data memory. In particular, the expression “memory location that is dependent on the path information of the message” should be understood to mean that the messaging program saves the data attachment at the memory location that describes the path information of the message. In this connection, the expression “separately from the message text of the message” should particularly be understood to mean that the messaging program saves the message text at a different location and/or, in particular, that the messaging program discards the message text. The term “automatically” should particularly be understood to mean that the messaging program saves the data attachment, after receipt of the message, independent of any operator input. By means of the method according to the invention, particularly convenient saving of the data attachment is possible. In particular, a received message, with the data attachment, can be passed on to a processing unit by means of the messaging program, which program saves the data attachment automatically at a memory location selected by the operator.

In another embodiment, it is proposed that the processing unit has a data memory in which the messaging program saves the data attachment, at least in one operating state, specifically automatically, in advantageous manner, and separately from the message text of the message, thereby making particularly simple implementation of the messaging program possible. A “data memory” should particularly be understood to mean a memory that saves the data independent of a use of the data. Preferably, the date memory saves the data independent of a power supply of the data memory. It is advantageous if the data memory has at least one hard drive and/or a solid-state drive.

Furthermore, it is proposed that the messaging program saves the data attachment in a network memory, in at least one operating state, thereby making it possible to save the data conveniently, in particularly secure manner and so as to be accessible from different locations. In particular, a “network memory” should be understood to mean a memory that is intended for making files in a directory structure available by way of a network. Preferably, the network memory changes the data only as a function of a network access.

Furthermore, it is proposed that the messaging program, in at least one operating state, automatically saves only one data attachment of a message with a predetermined sender address, thereby making it possible to regulate saving of a data attachment by unauthorized persons. In particular, a “sender address” should be understood to be information that allows identification of the sender of the message, for example an email address and/or, advantageously, a telephone number of the sender.

In an advantageous embodiment of the invention, it is proposed that the path information is attached to a recipient address of the message, thereby making particularly simple implementation of the method in a messaging program and particularly convenient operation possible. A “recipient address” should particularly be understood to be an address of a recipient to whom the message is delivered after the message is sent. In particular, the term “attach” should be understood to mean that the path information is disposed in a fixed position relative to the recipient address, in an information strand, in at least one operating state. Preferably, the path information stands ahead of the recipient address. Alternatively, path information could be appended to the recipient address.

Furthermore, it is proposed that the messaging program evaluates proof of authorization for saving the data attachment contained in the message, thereby making it possible to prevent saving of a data attachment by unauthorized persons. In particular, “proof of authorization” should be understood to mean information attached to the message, which documents authorization of the sender to save the data attachment. Preferably, the messaging program checks a signature of the sender of the message. It is advantageous if the message is encrypted, at least in part, whereby a key used for encryption is advantageously used as proof of authorization.

Alternatively, the proof of authorization could be configured as a password.

In another embodiment, it is proposed that the message is configured as an email, thereby making widespread use of the method according to the invention possible in simple manner, in terms of design. An “email” should particularly be understood to mean a message according to the “RFC 5322” standard.

Furthermore, it is proposed that the message is configured as a push message transmitted by way of a cellular network, thereby making convenient use on mobile devices possible in simple manner, in terms of design. In particular, a “push message” should be understood to be a message transmitted by way of a cellular network, according to the specifications for WAP push.

Furthermore, it is proposed that the method comprises a further processing unit having a messaging program, which unit transmits a message with a message text, a data attachment, and path information by way of the network interface in at least one operating state, thereby making saving and transmission to a further messaging program that saves the data attachment possible with a single messaging program. Preferably, the messaging program has at least part of, preferably the entire functionality of the messaging program that receives the message in at least one operating state.

### DRAWINGS

Further advantages are evident from the following drawing description. In the drawings, an exemplary embodiment of the invention is shown. The drawings, the description, and the claims contain numerous characteristics in combination. A person skilled in the art will also consider the characteristics individually, in practical manner, and will bring them together in practical further combinations.

The drawings show:

FIG. 1 a system according to the invention, having four processing units, and

FIG. 2 a message transmitted by the system from FIG. 1.

### DESCRIPTION OF THE EXEMPLARY EMBODIMENT

FIG. 1 shows a system having a first, second, third, and fourth processing unit 10, 12, 14, 16. The processing units 10, 12, 14, 16, in each instance, have a network interface 18, 20, 22, 24, a data memory 42, 44, 46, 48, and, not shown in any detail, a processor, a random-access memory, a display unit, as well as other components that appear practical to a person skilled in the art. Furthermore, the processing units 10, 12, 14, 16, in each instance, have a messaging program 26, 28, 30, 32 that is saved in the random-access memory in an operating mode and executed by the processor. The processing units 10, 12, 14, 16 are connected with one another by way of the network interfaces 18, 20, 22, 24 and by way of a network 58. The network comprises parts of a cellular network 56, parts of the Internet 60, and, not shown in any detail here, further network parts and interfaces between the networks that appear practical to a person skilled in the art.

The messaging programs 26, 28, 30, 32 send and/or receive messages 34 shown in FIG. 2 by way of the network interfaces 18, 20, 22, 24 in an operating mode. The messages 34 comprise, in each instance, a message text 36, a data attachment 38, path information 40, a sender address 50, proof of authorization 52, and a recipient address 54. The message 34 shown is configured as an email. Not shown in any detail is a message configured as a push message, sent by the messaging program 28, 32 in an operating mode. The message configured as a push message has the properties corresponding to the message 34 configured as an email.

The message text 36 has a text that can be determined by an operator. The data attachment 38 has at least one file that can be selected by the operator. The sender address 50 and the recipient address 54 are configured in accordance with the RFC 5322 standard. The sender address 50 reads “abc@def.ghi” in this exemplary embodiment. The recipient address 54 reads “jkl@mno.pqr” in this exemplary embodiment. The path information 40 is attached to the recipient address 54; specifically, the path information 40 precedes the recipient address 54, in other words attached at the front of the recipient address 54. The recipient address 54 has a local part “jkl” and a global part “mno.pqr,” which parts are separated by the symbol “@.” The path information 40 precedes the local part of the recipient address 54.

The path information 40 is separated from the recipient address 54 by means of a separator 62 of the message 34. In this embodiment, the separator 62 is configured as the hash mark “#.” If the recipient address 54 contains a symbol that corresponds to the separator 62, the messaging program 26, 28, 30, 32 that sends the message 34 replaces the corresponding symbol with a replacement sequence of symbols, in this case two symbols that correspond to the separator 62. The messaging program 26, 28, 30, 32 that receives this message 34 interprets the replacement sequence of symbols as a symbol assigned to the recipient address 54 and corresponding to the separator 62.

The messaging programs 26, 28, 30, 32 automatically save the data attachment 38 at a memory location that depends on the path information 40 of the message 34, separately from the message text 36 of the message 34, when the messaging programs 26, 28, 30, 32 recognize that the path information 40 is attached to the message 34. The messaging programs 26, 28, 30, 32 have a configuration function by means of which an operator can choose a data memory 42, 44, 46, 48 in the directory structure of which the data attachment 38 is saved as a function of the path information 40. Furthermore, the operator can activate or deactivate automatic saving of the data attachment 38. In this connection, the data memory 42, 44, 46, 48 can belong to the same processing unit 10, 12, 14, 16 as the messaging programs 26, 28, 30, 32 or can be configured as a network memory 51 that is configured separately from the processing units 10, 12, 14, 16.

The first processing unit 10 is configured as a desktop computer. The messaging program 26 of the first processing unit 10 is configured as an email program for an end user, in other words as an email client. An operator sends a message 34 having the message text 36, the data attachment 38, and the path information 40, using the messaging program 26 of the first processing unit 10, to the recipient address 54 of the third processing unit 14.

The second processing unit 12 is configured as a server. The messaging program 28 of the second processing unit 12 is configured as an email server. The network 58 passes the message 34 on to the second processing unit 12. In this exemplary embodiment, the global part of the recipient address 54 is assigned to the second processing unit 12. The messaging program 28 of the second processing unit 12 saves the complete message 34, specifically in the data memory 44 of the second processing unit 12. Furthermore, the messaging program 28 of the second processing unit 12 automatically saves the data attachment 38, separately from the message text 36 of the message 34, in a memory location that depends on the path information 40 of the message 34, specifically in a directory structure in a data memory 44 of the second processing unit 12.

The messaging program 30 of the third processing unit 14 calls up the message 34 from the second processing unit 12. The third processing unit 14 is configured as a desktop computer. The messaging program 30 of the second processing unit 12 is configured as an email program for an end user. The messaging program 30 of the third processing unit 14 automatically saves the data attachment 38 in a memory location that depends on the path information 40 of the message 34, separately from the message text 36 of the message 34. Furthermore, the messaging program 30 of the third processing unit 14 saves the message text 36 of the message 34 separately from the data attachment 38 of the message 34. The messaging program 30 of the third processing unit 14 saves the data attachment 38 in the directory structure on the network memory 51 of the system. Alternatively or additionally, the messaging program 30 of the third processing unit 14 could save the data attachment 38 in a directory structure of the data memory 44 of the third processing unit 14.

The fourth processing unit 16 is configured as a mobile telephone. The messaging program 32 of the fourth processing unit 16 is configured as a program for push messages according to the specifications for WAP push. An operator creates and sends a message, not shown in any detail here, having a message text, a data attachment, path information, and a password, from the messaging program 32 of the fourth processing unit 16 to a recipient address that is assigned to the second processing unit 12. The second processing unit 12 automatically saves the data attachment 38. In this exemplary embodiment, the processing unit 12 saves the data attachment 38 in the network memory 51. Thereby the operator can transfer data from the mobile telephone to the network memory 51 in particularly simple manner.

Alternatively or additionally, the fourth processing unit 16 could transmit a message as an email and/or the third processing unit 14 could automatically save the data attachment 38 in its data memory 46.

The proof of authorization 52 of the message 34 is configured as a digital signature. The proof of authorization 52 is based on asymmetrical encryption. The messaging programs 26, 28, 30, 32 evaluate the proof of authorization 52 contained in the message 38 for saving the data attachment 38. Only once the proof of authorization 52 has been activated do the messaging programs 26, 28, 30, 32 save the data attachment 38 automatically.

### REFERENCE SYMBOLS

10 processing unit

12 processing unit

14 processing unit

16 processing unit

18 network interface

20 network interface

22 network interface

24 network interface

26 messaging program

28 messaging program

30 messaging program

32 messaging program

34 message

36 message text

38 data attachment

40 path information

42 data memory

44 data memory

46 data memory

48 data memory

50 sender address

51 network memory

52 proof of authorization

54 recipient address

56 cellular network

58 network

60 Internet

62 separator

1. Method involving at least one processing unit (10, 12, 14, 16), which method has at least one network interface (18, 20, 22, 24) and one messaging program (26, 28, 30, 32), which, in at least one operating state, receives a message (34) containing a message text (36) and a data attachment (38) by way of the network interface (18, 20, 22, 24), wherein
the messaging program (26, 28, 30, 32) automatically saves the data attachment (38) separately from the message text (36) of the message (34), at a memory location that is dependent on the path information (40) of the message (34).

2. Method according to claim 1, wherein
the processing unit (10, 12, 14, 16) has a data memory (42, 44, 46, 48) to which the messaging program (26, 28, 30, 32) saves the data attachment (38), in at least one operating state.

3. Method according to claim 1, wherein
the messaging program (26, 28, 30, 32) saves the data attachment (38) in a network memory (51), in at least one operating state.

4. Method according to claim 1, wherein
the messaging program (26, 28, 30, 32) automatically saves only one data attachment (38) of a message (34) having a predetermined sender address (50), in at least one operating state.

5. Method according to claim 1, wherein
the path information (40) can be attached to a recipient address (54) of the message (34).

6. Method according to claim 1, wherein
the messaging program (26, 28, 30, 32) evaluates proof of authorization (52) for saving the data attachment (38) contained in the message (34).

7. Method according to claim 1, wherein
the message (34) is configured as an email.

8. Method according to claim 1, wherein
the message is configured as a push message transmitted by way of a cellular network (56).

9. Method according to claim 1, further comprising
a further processing unit (10, 12, 14, 16) having a messaging program (26, 28, 30, 32), which unit sends a message (34) having a message text (36), a data attachment (38), and path information (40) by way of the network interface (18, 20, 22, 24), in at least one operating state.

10. System having a processing unit (10, 12, 14, 16) according to claim 1.
